(19) United States
(12) Patent Application Publication
(10) Pub. No.: US 2026/0285399 A1
(43) Pub. Date: Sep. 24, 2026

(54) STEERING SYSTEM CONTROL

(71) Applicant: Ford Global Technologies, LLC, Dearborn, MI (US)

(72) Inventor: Scott Julian Varnhagen, Ann Arbor, MI (US)

(73) Assignee: Ford Global Technologies, LLC, Dearborn, MI (US)

(21) Appl. No.: 19/084,946

(22) Filed: Mar. 20, 2025

(51) Int. Cl. B62D 6/08; B62D 6/00; B62D 15/02

(52) U.S. Cl. CPC B62D 6/08; B62D 6/002; B62D 15/0265

(57) ABSTRACT

A computer includes a processor and a memory, and the memory stores instructions executable to, while an autonomous steering mode is engaged for a vehicle, receive a steering-wheel input; in response to the steering-wheel input being below a threshold, determine a nominal path by a trajectory planner without regard to the steering-wheel input, and actuate a steering system of the vehicle to follow the nominal path; and in response to the steering-wheel input exceeding the threshold, determine an adjusted path by the trajectory planner with the steering-wheel input as an input to the trajectory planner, and actuate the steering system to follow the adjusted path.

### BACKGROUND

A steering system for a vehicle controls the steering of the vehicle wheels. Types of steering systems include rack-and-pinion systems, often with electric power-assisted steering; other mechanical arrangements; and steer-by-wire systems. The steering system typically includes an electronic control unit (ECU) that is in communication with and receives input from a controller and/or a human driver. The human driver typically controls the steering system via a steering wheel.

### BRIEF DESCRIPTION OF THE DRAWINGS

FIG. 1 is a block diagram of an example vehicle.

FIG. 2 is a diagrammatic top view of the vehicle showing a steering system of the vehicle.

FIG. 3 is a block diagram of an example architecture for controlling the steering system.

FIG. 4 is a diagrammatic top view of the vehicle traveling through an example environment.

FIG. 5 is a flowchart of an example process for controlling the steering system.

### DETAILED DESCRIPTION

The disclosure provides techniques for autonomously controlling a steering system of a vehicle. The system described herein can take inputs from the human operator to adjust how the steering system is autonomously controlled while still keeping the autonomous steering in operation. A computer of the vehicle is programmed to, while an autonomous steering mode is engaged for a vehicle, receive a steering-wheel input from the operator; in response to the steering-wheel input being below a threshold, determine a nominal path by a trajectory planner without regard to the steering-wheel input, and actuate a steering system of the vehicle to follow the nominal path; and in response to the steering-wheel input exceeding the threshold, determine an adjusted path by the trajectory planner with the steering-wheel input as an input to the trajectory planner, and actuate the steering system to follow the adjusted path. The use of the threshold can separate likely inadvertent inputs below the threshold from likely intentional inputs above the threshold. Steering-wheel inputs above the threshold cause the use of the adjusted path rather than the nominal path (e.g., biasing the vehicle laterally within a lane of travel), while still keeping the vehicle in the autonomous steering mode. The use of the same trajectory planner for the nominal path and adjusted path means that constraints on setting a path will apply to both the nominal path and the adjusted path, which may not be the case if an input from the operator were to adjust the path outputted by the trajectory planner or the resulting steering torque directly. Constraints may include, for example, steering around obstacles in the environment.

A computer includes a processor and a memory, and the memory stores instructions executable to, while an autonomous steering mode is engaged for a vehicle, receive a steering-wheel input; in response to the steering-wheel input being below a threshold, determine a nominal path by a trajectory planner without regard to the steering-wheel input, and actuate a steering system of the vehicle to follow the nominal path; and in response to the steering-wheel input exceeding the threshold, determine an adjusted path by the trajectory planner with the steering-wheel input as an input to the trajectory planner, and actuate the steering system to follow the adjusted path.

In an example, the threshold may be a lower threshold, and the instructions may further include instructions to, in response to the steering-wheel input exceeding an upper threshold, actuate the steering system as a function of the steering-wheel input. In a further example, the instructions to actuate the steering system as a function of the steering-wheel input may include instructions to actuate the steering system without feedback from the trajectory planner.

In another further example, the instructions may further include instructions to, in response to the steering-wheel input exceeding the lower threshold and being below the upper threshold, maintain the autonomous steering mode as engaged.

In an example, the trajectory planner may be programmed to determine paths subject to environmental constraints. In a further example, the environmental constraints may be based on features of an environment surrounding the vehicle.

In another further example, the environmental constraints may include to steer the vehicle around objects in an environment surrounding the vehicle.

In an example, the adjusted path may be offset within a lane of travel of the vehicle with respect to the nominal path.

In an example, the steering-wheel input may be an input torque applied to a steering wheel of the vehicle by an operator of the vehicle. In a further example, the trajectory planner may be programmed to determine the adjusted path as a function of a magnitude of the input torque. In a still further example, the adjusted path is offset within a lane of travel of the vehicle with respect to the nominal path, and the trajectory planner may determine a magnitude of the offset as a function of the magnitude of the input torque.

In an example, the instructions to actuate the steering system to follow the nominal path and to actuate the steering system to follow the adjusted path may include instructions to determine a steering angle for the steering system by a lateral planner based on the nominal path or adjusted path. In a further example, the lateral planner may be programmed to determine the steering angle without regard to the steering-wheel input.

In another further example, the steering angle may be a planned steering angle, and the instructions to actuate the steering system to follow the nominal path and to actuate the steering system to follow the adjusted path may include instructions to execute a feedback loop to adjust a steering torque until a measured steering angle of the steering system equals the planned steering angle.

A method includes, while an autonomous steering mode is engaged for a vehicle, receiving a steering-wheel input; in response to the steering-wheel input being below a threshold, determining a nominal path by a trajectory planner without regard to the steering-wheel input, and actuating a steering system of the vehicle to follow the nominal path; and in response to the steering-wheel input exceeding the threshold, determining an adjusted path by the trajectory planner with the steering-wheel input as an input to the trajectory planner, and actuating the steering system to follow the adjusted path.

In an example, the threshold may be a lower threshold, and the method may further include, in response to the steering-wheel input exceeding an upper threshold, actuating the steering system as a function of the steering-wheel input.

In an example, the trajectory planner may be programmed to determine paths subject to environmental constraints.

In an example, the adjusted path may be offset within a lane of travel of the vehicle with respect to the nominal path.

In an example, the steering-wheel input may be an input torque applied to a steering wheel of the vehicle by an operator of the vehicle.

In an example, actuating the steering system to follow the nominal path and actuating the steering system to follow the adjusted path may include determining a steering angle for the steering system by a lateral planner based on the nominal path or adjusted path.

With reference to the Figures, wherein like numerals indicate like parts throughout the several views, a computer 105 includes a processor and a memory, and the memory stores instructions executable to, while an autonomous steering mode 305 is engaged for a vehicle 100, receive a steering-wheel input 325; in response to the steering-wheel input 325 being below a threshold, determine a nominal path 355a by a trajectory planner 330 without regard to the steering-wheel input 325, and actuate a steering system 110 of the vehicle 100 to follow the nominal path 355a; and in response to the steering-wheel input 325 exceeding the threshold, determine an adjusted path 355b by the trajectory planner 330 with the steering-wheel input 325 as an input to the trajectory planner 330, and actuate the steering system 110 to follow the adjusted path 355b.

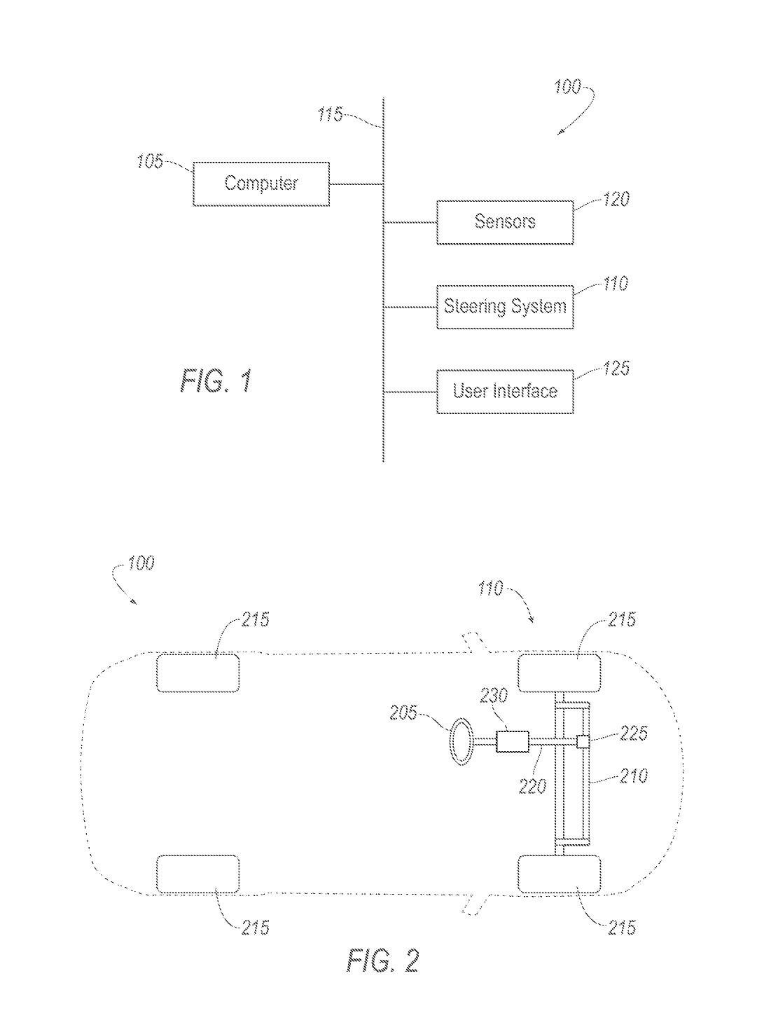

With reference to FIG. 1, the vehicle 100 may be any passenger or commercial automobile such as a car, a truck, a sport utility vehicle, a crossover, a van, a minivan, a taxi, a bus, etc. The vehicle 100 includes the computer 105, a communications network 115, sensors 120, the steering system 110, and a user interface 125.

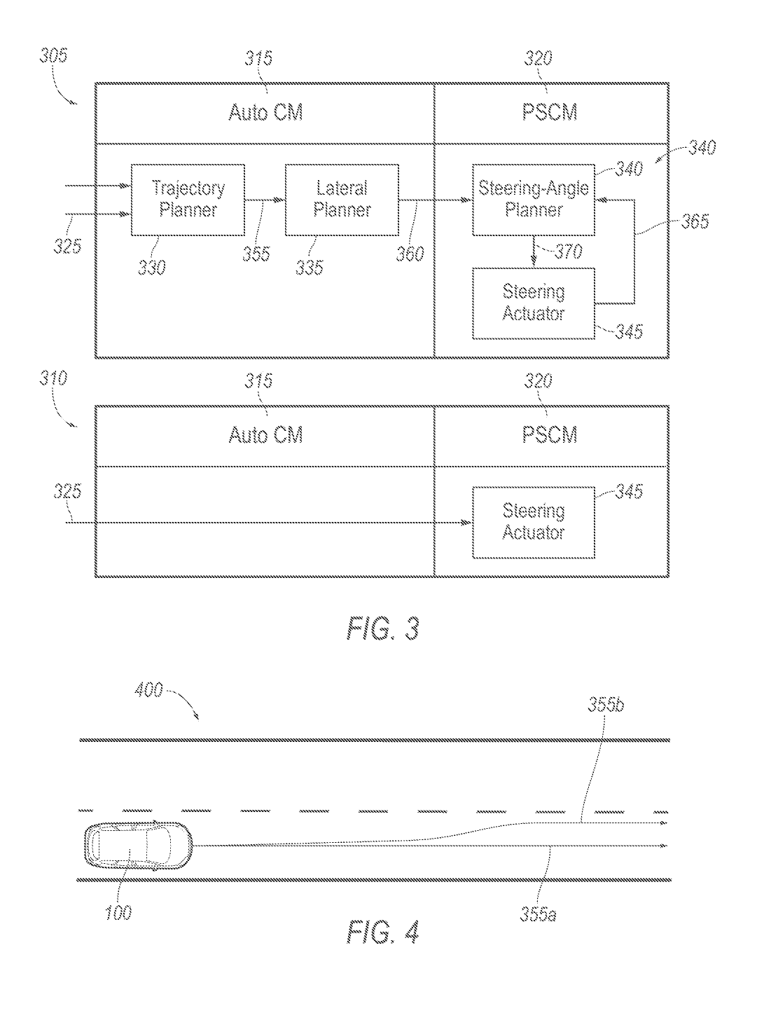

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together. For example, as described below with respect to FIG. 3, the computer 105 may include an autonomy control module 315 and a power-steering control module 320.

The computer 105 may transmit and receive data through the communications network 115. The communications network 115 may be a controller area network (CAN) bus, Ethernet, WiFi, Local Interconnect Network (LIN), onboard diagnostics connector (OBD-II), and/or any other wired or wireless communications network. The computer 105 may be communicatively coupled to the steering system 110, the sensors 120, the user interface 125, and other components via the communications network 115.

The sensors 120 may provide data about operation of the vehicle 100, for example, wheel speed, wheel orientation, and engine and transmission data (e.g., temperature, fuel consumption, etc.). The sensors 120 may detect the location and/or orientation of the vehicle 100. For example, the sensors 120 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 120 may detect the external world, including objects and/or characteristics of surroundings of the vehicle 100, such as other vehicles, road lane markings, traffic lights and/or signs, road users, etc. For example, the sensors 120 may include radar sensors, ultrasonic sensors, scanning laser range finders, light detection and ranging (lidar) devices, and image processing sensors such as cameras.

The steering system 110 is typically a conventional vehicle steering subsystem and controls the lateral motion of the vehicle 100. The steering system 110 controls the lateral motion of the vehicle 100 via vehicle wheels 215. The steering system 110 may steer front vehicle wheels 215 (as shown in FIG. 2), may steer rear vehicle wheels 215, or may actuate a differential drive (e.g., by rotating the right vehicle wheels 215 forward and the left vehicle wheels 215 rearward to turn the vehicle 100 left). The steering system 110 may be a rack-and-pinion system with electric power-assisted steering, a steer-by-wire system, as both are known, or any other suitable system. The steering system 110 can include an electronic control unit (ECU) or the like (e.g., the power-steering control module 320) that is in communication with and receives input from the computer 105 and/or a human operator. The human operator may control the steering system 110 via, for example, a steering wheel 205 (shown in FIG. 2).

The user interface 125 presents information to and receives information from an operator of the vehicle 100. The user interface 125 may be located on an instrument panel in a passenger compartment of the vehicle 100, and/or wherever may be readily seen by the operator. The user interface 125 may include dials, digital readouts, screens, speakers, and so on for providing information to the operator, such as human-machine interface (HMI) elements such as are known. The user interface 125 may include buttons, knobs, keypads, microphone, and so on for receiving information from the operator.

With reference to FIG. 2, the steering system 110 may be a conventional rack-and-pinion steering system. Alternatively or additionally, the steering system 110 may be a Pitman-arm system, a rear-steer system, etc. (not shown). A steering rack 210 may be turnably coupled to vehicle wheels 215, for example, in a four-bar linkage. The position of the steering rack 210 determines the turning of the vehicle wheels 215. Translational motion of the steering rack 210 results in turning of the vehicle wheels 215. A steering column 220 may be coupled to the steering rack 210 via a pinion gear 225, that is, gear meshing between the pinion gear 225 and the steering rack 210.

The steering column 220 transfers rotation of the steering wheel 205 to movement of the steering rack 210. The steering column 220 may be, for example, a shaft connecting the steering wheel 205 to the steering rack 210. The steering column 220 may house a clutch and one or more of the sensors 120 such as a torque sensor (not shown).

The steering wheel 205 allows an operator to steer the vehicle 100 by transmitting rotation of the steering wheel 205 to movement of the steering rack 210. The steering wheel 205 may be, for example, a rigid ring fixedly attached to the steering column 220 such as is known. Alternatively, another type of device may accept the steering-wheel input 325, such as a joystick or touchscreen.

A steering motor 230 is coupled to the steering system 110 (e.g., drivably coupled to the steering column 220) so as to cause turning of the vehicle wheels 215. For example, the steering motor 230 may be rotatably coupled to the steering column 220, that is, coupled so as to be able to apply a torque to the steering column 220. The steering motor 230 may be an electric-power-assist-steering motor, in other words, may provide power assist to the steering system 110. In other words, during a manual steering mode 310, the steering motor 230 may provide torque in a direction in which the steering wheel 205 is being rotated by a human operator, allowing the driver to turn the steering wheel 205 with less effort. During autonomous or semi-autonomous control of the steering system 110, the steering motor 230 can apply torque to the steering column 220 with or without input from the human operator based on instructions from the computer 105, as will be described below.

Alternatively to the rack-and-pinion steering system, the steering system 110 may be a steer-by-wire steering system, in other words, may have a gap in mechanical linkages between the steering wheel 205 and the vehicle wheels 215. The computer 105 (e.g., the power-steering control module 320) may receive signals from the sensors 120 (e.g., a position sensor positioned to detect the orientation of the steering wheel 205), or may determine a desired turning of the vehicle wheels 215 during autonomous or semi-autonomous control. The position sensor may be, for example, a Hall effect sensor, a rotary encoder, etc. The computer 105 may output a signal to the steering motor 230. The steering motor 230 may be one or more electromechanical actuators coupled to the steering rack 210 in lieu of the pinion gear 225, and the steering motor 230 may transform the signal into mechanical motion of the steering rack 210.

With reference to FIG. 3, the computer 105 may operate the steering system 110 in an autonomous steering mode 305 or a manual steering mode 310. A programming architecture of the autonomous steering mode 305 is shown in the top panel of FIG. 3, and a programming architecture of the manual steering mode 310 is shown in the bottom panel of FIG. 3. In the autonomous steering mode 305, the computer 105 controls the turning of the vehicle wheels 215 without needing input from an operator of the vehicle 100. (The operator may still be required to watch the road while the autonomous steering mode 305 is engaged.) The operator may choose to provide or not provide inputs that affect the lateral motion of the vehicle 100, as described below. In the manual steering mode 310, the computer 105 controls the turning of the vehicle wheels 215 based on continual input from the operator via the steering wheel 205.

The computer 105 may be programmed to enter the autonomous steering mode 305 or the manual steering mode 310 based on an input from the operator. For example, the operator may provide the input via the user interface 125. The computer 105 may be in at most one of the autonomous steering mode 305 or the manual steering mode 310 at one time. The computer 105 may be programmed to enter other modes besides the autonomous steering mode 305 and manual steering mode 310. In response to receiving an input to enter the manual steering mode 310, the computer 105 exits the autonomous steering mode 305 and enters the manual steering mode 310. In response to receiving an input to enter the autonomous steering mode 305, the computer 105 exits the manual steering mode 310 and enters the autonomous steering mode 305. Exiting the manual steering mode 310 and entering the autonomous steering mode 305 may be conditional on certain conditions being met, such as with respect to the speed of the vehicle 100, the road in which the vehicle 100 is traveling, the external environment and/or weather conditions around the vehicle 100, etc.

The programming architecture of the autonomous steering mode 305 may include the trajectory planner 330, a lateral planner 335, a steering-angle planner 340, and a steering actuator 345. The trajectory planner 330, the lateral planner 335, the steering-angle planner 340, and the steering actuator 345 are programming modules. While the autonomous steering mode 305 is engaged for the vehicle 100, the computer 105 executes the trajectory planner 330, the lateral planner 335, the steering-angle planner 340, and the steering actuator 345. For example, the autonomy control module 315 may execute the trajectory planner 330 and the lateral planner 335, and the power-steering control module 320 may execute the steering-angle planner 340 and the steering actuator 345.

As a general overview, the trajectory planner 330 receives the steering-wheel input 325 (if any) and environmental data 350, and the trajectory planner 330 outputs a path 355. The lateral planner 335 receives the path 355 and outputs a planned steering angle 360. The steering-angle planner 340 receives the planned steering angle 360 and a measured steering angle 365, and the steering-angle planner 340 outputs a requested steering torque 370 to the steering actuator 345. The steering actuator 345 actuates the steering motor 230 to apply the requested steering torque 370 and outputs the measured steering angle 365 to the steering-angle planner 340, thereby forming a feedback loop 375 with the steering-angle planner 340.

The computer 105 (e.g., the autonomy control module 315) is programmed to receive the steering-wheel input 325. In the example described herein, the steering-wheel input 325 is an input torque applied to the steering wheel 205 by the operator. Alternatively, the steering-wheel input 325 may be a steering-wheel angle of the steering wheel 205. Using the input torque may be preferable because the operator does not need to overcome the requested steering torque 370 that is being applied to the steering wheel 205 via the steering column 220 as the steering system 110 controls the turning of the vehicle wheels 215. The sensors 120 may include a torque sensor that measures the input torque. The torque sensor may report values of the input torque to the computer 105 at a predetermined rate, which may be a characteristic of the torque sensor. When the operator is not touching the steering wheel 205, the input torque may be zero. In other words, the operator is not applying an input torque to the steering wheel 205.

The trajectory planner 330 determines a path 355 based on data indicating features of an environment 400 surrounding the vehicle 100 and (under certain circumstances described below) based on the steering-wheel input 325. As shown in FIG. 4, the path 355 describes where the vehicle 100 is planning to move through space. A path 355 determined without regard to the steering-wheel input 325 is referred to as a nominal path 355a, and a path 355 determined with the steering-wheel input 325 as an input to the trajectory planner 330 is referred to as an adjusted path 355b (as will be described in more detail with respect to FIG. 4 below).

The trajectory planner 330 determines the path 355 based at least in part on the environmental data 350, which indicates features of an environment 400 surrounding the vehicle 100. The features of the environment 400 are things or characteristics of the environment 400 surrounding the vehicle 100, such as lane lines, other vehicles, other road users, traffic signals, infrastructure, barriers, buildings, trees, other obstacles, etc. The environmental data 350 may include sensor data, map data, V2X (vehicle-to-anything) data, etc. For example, the trajectory planner 330 may determine a path 355 from a current position to a destination or waypoint subject to environmental constraints. The environmental constraints may be based on the features of the environment 400. For example, an environmental constraint may be to steer the vehicle 100 within lane lines of a current lane of travel (unless a contravening constraint would be violated). For another example, an environmental constraint may be to steer the vehicle 100 around objects in the environment 400.

The trajectory planner 330 may include any suitable local path-planning algorithm, such as an artificial potential field algorithm, a vortex artificial potential field algorithm, a dynamic window approach, etc. For example, the algorithm may determine an optimal path (in terms of distance, energy consumption, operator comfort, etc.) from the current position to the destination or waypoint, subject to any environmental constraints. Executing the trajectory planner 330 includes executing the local path-planning algorithm.

The lateral planner 335 determines the planned steering angle 360 based on the path 355 from the trajectory planner 330 (i.e., based on whichever of the nominal path 355a or adjusted path 355b is outputted by the trajectory planner 330). For example, the lateral planner 335 may determine the steering angle that will achieve a curvature of the path 355 at the current position of the vehicle 100 along the path 355, and output that steering angle as the planned steering angle 360. The lateral planner 335 may determine the planned steering angle 360 based on a physics-based model of the kinematics of the vehicle 100 (e.g., a bicycle model). The lateral planner 335 may be programmed to determine the planned steering angle 360 without regard to the steering-wheel input 325. As shown in FIG. 3, the steering-wheel input 325 is not provided as an input to the lateral planner 335. The lateral planner 335 instead receives the path 355. Thus, the steering-wheel input 325 is subjected to the environmental constraints before the resulting path 355 is provided to the lateral planner 335.

The computer 105 (e.g., the power-steering control module 320) is programmed to execute a feedback loop 375 to adjust the requested steering torque 370 until the measured steering angle 365 of the steering system 110 equals the planned steering angle 360. The feedback loop 375 is formed of the steering-angle planner 340 and the steering actuator 345. The steering-angle planner 340 determines a requested steering torque 370 based on the planned steering angle 360 from the lateral planner 335 and the measured steering angle 365 from the steering actuator 345. For example, the steering-angle planner 340 may include a proportional-integral-derivative control algorithm or the like. The steering actuator 345 may receive the measured steering angle 365 from a position sensor of the sensors 120. The steering actuator 345 actuates the steering system 110 (e.g., the steering motor 230) to apply the requested steering torque 370 (e.g., to the steering column 220, pinion gear 225, or whichever component of the steering system 110 will result in turning the vehicle wheels 215).

The programming architecture of the manual steering mode 310 includes the steering actuator 345. While the manual steering mode 310 is engaged for the vehicle 100, the computer 105 (e.g., the power-steering control module 320) executes the steering actuator 345. The steering actuator 345 actuates the steering system 110 as a function of the steering-wheel input 325. For example, the steering actuator 345 actuates the steering system 110 (e.g., the steering motor 230) to apply the input torque (possibly multiplied by a gain). The steering actuator 345 may look up the gain in a prestored boost curve. The programming architecture of the manual steering mode 310 does not include the trajectory planner 330, the lateral planner 335, or the steering-angle planner 340. The steering actuator 345 actuates the steering system 110 (e.g., the steering motor 230) without feedback from the trajectory planner 330, direct or indirect.

With reference to FIG. 4, the vehicle 100 is depicted traveling through the environment 400 in the autonomous steering mode 305. As a general overview, the computer 105 receives the steering-wheel input 325 while the autonomous steering mode 305 is engaged. Depending on the value of the steering-wheel input 325, the computer 105 either executes the trajectory planner 330 to determine the nominal path 355a without regard to the steering-wheel input 325, executes the trajectory planner 330 to determine the adjusted path 355b with the steering-wheel input 325 as an input to the trajectory planner 330, or actuates the steering system 110 as a function of the steering-wheel input 325 without feedback from the trajectory planner 330. The computer 105 may iteratively perform this control of the steering system 110 as values for the steering-wheel input 325 are received, until the computer 105 exits the autonomous steering mode 305.

The computer 105 is programmed to compare the steering-wheel input 325 to one or more thresholds, for example, a lower threshold and an upper threshold. The upper threshold is greater than the lower threshold. In response to the steering-wheel input 325 being below the lower threshold, the computer 105 determines the nominal path 355a by the trajectory planner 330 without regard to the steering-wheel input 325. In response to the steering-wheel input 325 exceeding the lower threshold (e.g., in response to the steering-wheel input 325 exceeding the lower threshold and being below the upper threshold), the computer 105 determines the adjusted path 355b by the trajectory planner 330 with the steering-wheel input 325 as an input to the trajectory planner 330. In response to the steering-wheel input 325 exceeding the upper threshold, the computer 105 may actuate the steering system 110 as a function of the steering-wheel input 325 without feedback from the trajectory planner 330. If the direction of the steering-wheel input 325 is indicated by the sign of the steering-wheel input 325 (e.g., positive indicating left and negative indicating right), then the magnitude (i.e., absolute value) of the steering-wheel input 325 is compared to the thresholds. The lower threshold and upper threshold may be predetermined values stored in the memory of the computer 105. The lower threshold may be chosen to distinguish between intentional and inadvertent inputs by the operator. The upper threshold may be chosen to indicate a desire by the operator for an immediate response by the steering system 110.

The computer 105 is programmed to, in response to the steering-wheel input 325 being below the lower threshold, determine the nominal path 355a by the trajectory planner 330 without regard to the steering-wheel input 325, and actuate the steering system 110 to follow the nominal path 355a. The trajectory planner 330 determines the nominal path 355a based on the environmental data 350 (e.g., subject to the environmental constraints) as described above. The computer 105 executes the lateral planner 335, the steering-angle planner 340, and the steering actuator 345 based on the nominal path 355a in order to actuate the steering system 110 according to the requested steering torque 370, as described above.

The computer 105 is programmed to, in response to the steering-wheel input 325 exceeding the lower threshold and being below the upper threshold, determine the adjusted path 355b by the trajectory planner 330 with the steering-wheel input 325 as an input to the trajectory planner 330, and actuate the steering system 110 to follow the adjusted path 355b. The trajectory planner 330 determines the adjusted path 355b based on the steering-wheel input 325 and based on the environmental data 350 (e.g., subject to the environmental constraints), as described immediately below. The computer 105 executes the lateral planner 335, the steering-angle planner 340, and the steering actuator 345 based on the adjusted path 355b in order to actuate the steering system 110 according to the requested steering torque 370, as described above.

In this case, the trajectory planner 330 determines the adjusted path 355b based on the steering-wheel input 325. For example, the steering-wheel input 325 may bias the adjusted path 355b away from the nominal path 355a that the trajectory planner 330 would output in the absence of the steering-wheel input 325. The trajectory planner 330 may determine the adjusted path 355b as a function of magnitude and/or direction of the steering-wheel input 325 (e.g., of the input torque). The direction of the steering-wheel input 325 may be indicated by the sign (positive or negative) of the steering-wheel input 325. The magnitude of the steering-wheel input 325 may indicate how much to bias the adjusted path 355b away from the nominal path 355a, and the direction may indicate which lateral direction (i.e., left or right) to bias the adjusted path 355b away from the nominal path 355a. For example, the adjusted path 355b may be offset within a lane of travel of the vehicle 100 with respect to the nominal path 355a, as shown in the example of FIG. 4. The offset may be measured as a lateral distance from a center of the lane to a center point of the vehicle 100. The trajectory planner 330 may determine the magnitude of the offset as a function of the magnitude of the steering-wheel input 325 (e.g., of the input torque). The direction of the offset may be the same as the direction of the steering-wheel input 325. The trajectory planner 330 still determines the adjusted path 355b subject to the same environmental constraints as determining the nominal path 355a.

The offset may be a function of time in addition to the steering-wheel input 325. For example, the direction and magnitude of the steering-wheel input 325 may map onto a target offset. The target offset may be a maximum value of the offset of the adjusted path 355b over time. The offset may increase at a first rate of change up to the target offset and then decrease at a second rate of change from the offset to the nominal path 355a. The second rate of change may be smaller than the first rate of change; in other words, the offset may increase relatively quickly and then decrease relatively slowly. In effect, the vehicle 100 may move laterally off-center to the target offset and then drift back to the center of the lane. This decrease can help ensure that the offset is intentionally chosen by the operator for an entire duration of a trip.

The offset may be a function of a speed at which the vehicle 100 is traveling forward. For example, the offset may increase to the target offset more slowly at lower speeds than at higher speeds, which may feel more natural to the operator. The computer 105 may receive the speed from the sensors 120 (e.g., a speedometer or wheel speed sensor).

The offset may be independent of a curvature of the nominal path 355a. In other words, the offset may be the same when the vehicle 100 is turning as when the vehicle 100 is traveling straight, thereby providing a consistent feel to the operator.

The difference of the adjusted path 355b from the nominal path 355a may be constrained to be within a lateral range. For example, the offset may be constrained to a preset lateral distance from the center line of the lane. The preset lateral distance may be chosen to keep the vehicle 100 within the type of driving performed by the autonomous steering mode 305, for example, fully within the lane of travel.

The computer 105 is programmed to, in response to the steering-wheel input 325 being below the upper threshold, maintain the autonomous steering mode 305 as engaged, even when the steering-wheel input 325 exceeds the lower threshold. The operator can thus indirectly control the autonomous steering while keeping the autonomous steering mode 305 engaged.

The computer 105 is programmed to, in response to the steering-wheel input 325 exceeding the upper threshold, actuate the steering system 110 as a function of the steering-wheel input 325. The computer 105 may actuate the steering system 110 without feedback from the trajectory planner 330. For example, the computer 105 may actuate the steering system 110 in the same manner as described above for manual steering mode 310.

The computer 105 is programmed to, in response to the steering-wheel input 325 falling below the upper threshold after exceeding the upper threshold, engage the autonomous steering mode 305. If the previous steering-wheel input 325 has exceeded the upper threshold, the computer 105 may compare the current steering-wheel input 325 to the upper threshold as the next value of the steering-wheel input 325 is received or after a short timer expires. If the current steering-wheel input 325 is below the upper threshold, the computer 105 may then execute the trajectory planner 330 to determine either the nominal path 355a or adjusted path 355b (depending on whether the steering-wheel input 325 is above or below the lower threshold), as described above. The computer 105 executes the lateral planner 335, the steering-angle planner 340, and the steering actuator 345 based on the path 355 in order to actuate the steering system 110 to apply the requested steering torque 370, as described above. By reengaging the autonomous steering mode 305, the computer 105 permits the operator to directly control the steering system 110 to perform a desired maneuver and then relinquish control back to the computer 105, rather than the operator continuing to directly control the steering system 110 after the desired maneuver.

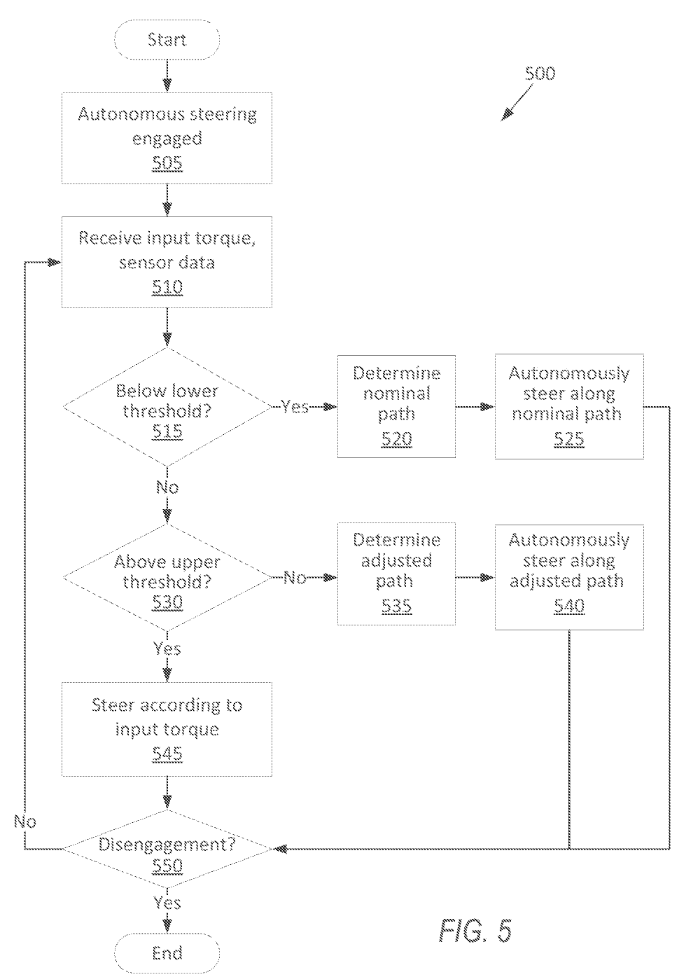

FIG. 5 is a flowchart illustrating an example process 500 for controlling the steering system 110. The memory of the computer 105 stores executable instructions for performing the steps of the process 500 and/or programming can be implemented in structures such as mentioned above. As a general overview of the process 500, the computer 105 engages the autonomous steering mode 305 and receives the steering-wheel input 325 and environmental data 350. In response to the steering-wheel input 325 being below the lower threshold, the computer 105 determines the nominal path 355a and actuates the steering system 110 to follow the nominal path 355a. In response to the steering-wheel input 325 exceeding the lower threshold and being below the upper threshold, the computer 105 determines the adjusted path 355b and actuates the steering system 110 to follow the adjusted path 355b. In response to the steering-wheel input 325 exceeding the upper threshold, the computer 105 actuates the steering system 110 as a function of the steering-wheel input 325. The process 500 repeats until the computer 105 receives an input from the operator to disengage the autonomous steering mode 305.

The process 500 begins in a block 505, in which the computer 105 engages the autonomous steering mode 305. The computer 105 may receive an input from the operator via the user interface 125 to engage the autonomous steering mode 305, as described above. The remaining blocks of the process 500 occur while the autonomous steering mode 305 is engaged for the vehicle 100.

Next, in a block 510, the computer 105 receives the steering-wheel input 325 and the environmental data 350, as described above.

Next, in a decision block 515, the computer 105 determines whether the steering-wheel input 325 from the block 510 exceeds the lower threshold. In response to the steering-wheel input 325 being below the lower threshold, the process 500 proceeds to a block 520. In response to the steering-wheel input 325 exceeding the lower threshold, the process 500 proceeds to a decision block 530.

In the block 520, the computer 105 determines the nominal path 355a by the trajectory planner 330 based on the environmental data 350 from the block 510, without regard to the steering-wheel input 325, as described above.

Next, in a block 525, the computer 105 actuates the steering system 110 of the vehicle 100 to follow the nominal path 355a from the block 520 (e.g., via the lateral planner 335, the steering-angle planner 340, and the steering actuator 345), as described above. After the block 525, the process 500 proceeds to a decision block 550.

In the decision block 530, the computer 105 determines whether the steering-wheel input 325 from the block 510 exceeds the upper threshold. In response to the steering-wheel input 325 being below the upper threshold, the process 500 proceeds to a block 535. In response to the steering-wheel input 325 exceeding the upper threshold, the process 500 proceeds to a block 545.

In the block 535, the computer 105 determines the adjusted path 355b by the trajectory planner 330 based on the environmental data 350 from the block 510, with the steering-wheel input 325 from the block 510 as an input to the trajectory planner 330, as described above.

Next, in a block 540, the computer 105 actuates the steering system 110 to follow the adjusted path 355b from the block 535 (e.g., via the lateral planner 335, the steering-angle planner 340, and the steering actuator 345), as described above. After the block 540, the process 500 proceeds to the decision block 550.

In the block 545, the computer 105 actuates the steering system 110 as a function of the steering-wheel input 325 from the block 510, as described above. After the block 545, the process 500 proceeds to the decision block 550.

In the decision block 550, the computer 105 determines whether the computer 105 received an input to exit the autonomous steering mode 305. The computer 105 may receive the input via the user interface 125. The input may be different then the steering-wheel input 325 and may result from some other form of input than turning the steering wheel 205 (e.g., pressing a button of the user interface 125, pressing a pedal, speaking to a voice-activation system, etc.). In the absence of an input to exit the autonomous steering mode 305, the process 500 returns to the block 510 to receive the next steering-wheel input 325 and environmental data 350. In response to receiving an input to exit the autonomous steering mode 305, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner’s/user’s manual and/or safety guidelines.

The disclosure has been described in an illustrative manner, and it is to be understood that the terminology which has been used is intended to be in the nature of words of description rather than of limitation. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable to:
while an autonomous steering mode is engaged for a vehicle, receive a steering-wheel input;
in response to the steering-wheel input being below a threshold:
determine a nominal path by a trajectory planner without regard to the steering-wheel input, and
actuate a steering system of the vehicle to follow the nominal path; and
in response to the steering-wheel input exceeding the threshold:
determine an adjusted path by the trajectory planner with the steering-wheel input as an input to the trajectory planner, and
actuate the steering system to follow the adjusted path.

2. The computer of claim 1, wherein:
the threshold is a lower threshold; and
the instructions further include instructions to, in response to the steering-wheel input exceeding an upper threshold, actuate the steering system as a function of the steering-wheel input.

3. The computer of claim 2, wherein the instructions to actuate the steering system as a function of the steering-wheel input include instructions to actuate the steering system without feedback from the trajectory planner.

4. The computer of claim 2, wherein the instructions further include instructions to, in response to the steering-wheel input exceeding the lower threshold and being below the upper threshold, maintain the autonomous steering mode as engaged.

5. The computer of claim 1, wherein the trajectory planner is programmed to determine paths subject to environmental constraints.

6. The computer of claim 5, wherein the environmental constraints are based on features of an environment surrounding the vehicle.

7. The computer of claim 5, wherein the environmental constraints include to steer the vehicle around objects in an environment surrounding the vehicle.

8. The computer of claim 1, wherein the adjusted path is offset within a lane of travel of the vehicle with respect to the nominal path.

9. The computer of claim 1, wherein the steering-wheel input is an input torque applied to a steering wheel of the vehicle by an operator of the vehicle.

10. The computer of claim 9, wherein the trajectory planner is programmed to determine the adjusted path as a function of a magnitude of the input torque.

11. The computer of claim 10, wherein the adjusted path is offset within a lane of travel of the vehicle with respect to the nominal path, and the trajectory planner is programmed to determine a magnitude of the offset as a function of the magnitude of the input torque.

12. The computer of claim 1, wherein the instructions to actuate the steering system to follow the nominal path and to actuate the steering system to follow the adjusted path include instructions to determine a steering angle for the steering system by a lateral planner based on the nominal path or adjusted path.

13. The computer of claim 12, wherein the lateral planner is programmed to determine the steering angle without regard to the steering-wheel input.

14. The computer of claim 12, wherein the steering angle is a planned steering angle, and the instructions to actuate the steering system to follow the nominal path and to actuate the steering system to follow the adjusted path include instructions to execute a feedback loop to adjust a steering torque until a measured steering angle of the steering system equals the planned steering angle.

15. A method comprising:
while an autonomous steering mode is engaged for a vehicle, receiving a steering-wheel input;
in response to the steering-wheel input being below a threshold:
determining a nominal path by a trajectory planner without regard to the steering-wheel input, and
actuating a steering system of the vehicle to follow the nominal path; and
in response to the steering-wheel input exceeding the threshold:
determining an adjusted path by the trajectory planner with the steering-wheel input as an input to the trajectory planner, and
actuating the steering system to follow the adjusted path.

16. The method of claim 15, wherein the threshold is a lower threshold, the method further including, in response to the steering-wheel input exceeding an upper threshold, actuating the steering system as a function of the steering-wheel input.

17. The method of claim 15, wherein the trajectory planner is programmed to determine paths subject to environmental constraints.

18. The method of claim 15, wherein the adjusted path is offset within a lane of travel of the vehicle with respect to the nominal path.

19. The method of claim 15, wherein the steering-wheel input is an input torque applied to a steering wheel of the vehicle by an operator of the vehicle.

20. The method of claim 15, wherein actuating the steering system to follow the nominal path and actuating the steering system to follow the adjusted path include determining a steering angle for the steering system by a lateral planner based on the nominal path or adjusted path.
